(19) United States
(12) Patent Application Publication
(10) Pub. No.: US 2026/0333176 A1
(43) Pub. Date: Oct. 22, 2026

(54) METHOD AND APPARATUS FOR DUAL CONNECTIVITY CONDITIONAL HANDOVER WITH ON-TIME DATA FORWARDNING

(71) Applicant: Nokia Technologies Oy, Espoo (FI)

(72) Inventors: Umur KARABULUT, Munich (DE); Ahmad AWADA, Munich (DE); Panagiotis SPAPIS, Munich (DE); Halit Murat GÜRSU, Munich (DE); Srinivasan SELVAGANAPATHY, Bangalore (IN)

(21) Appl. No.: 19/099,424

(22) PCT Filed: Jun. 6, 2023
(86) PCT No.: PCT/EP2023/065040

§ 371 Date: Jan. 28, 2025

(30) Foreign Application Priority Data
Jul. 29, 2022 (IN) 202241043624

(51) Int. Cl. H04W 36/36

(52) U.S. Cl. CPC H04W 36/362

(57) ABSTRACT

Methods and apparatuses of dual connectivity conditional handover with on-time data forwarding are presented. A user equipment configured to operating in dual connectivity during conditional handover, CHO, is presented that establishes a connection towards a primary cell of a source master node and towards a primary secondary cell of a source secondary node. The user equipment receives a transmission indication from the source master node, wherein the transmission indication enables the user equipment to send a CHO execution indication via the source secondary node towards the source master node. Finally, the user equipment transmits the CHO execution indication via the source secondary node towards the source master node and processes CHO towards a primary cell of a target master node. Methods, network nodes and functional units of the network nodes involved in the presented dual connectivity conditional handover are presented, too.

### TECHNICAL FIELD

The subject disclosure generally relates to wireless communication systems and, in particular, to conditional handover in wireless communication systems. Yet more particularly, the subject disclosure provides methods and apparatuses of dual connectivity conditional handover with on-time data forwarding.

### BACKGROUND

Wireless telecommunication systems are under constant development. There is a need for higher data rates and high quality of service. Reliability requirements are constantly rising and ways and means to ensure reliable connections and data traffic while keeping transmission delays minimal are constantly under development.

Developing networks enable new services to customers. One service is dual connectivity, in which a user equipment is connected with a master node base station and a secondary node base station for communication. Dual connectivity improves the data throughput and mobility robustness. Another service is conditional handover that further improves the mobility robustness. For conditional handover, the network may prepare multiple target cells, for which conditional handover configurations are associated with execution conditions evaluated by user equipments.

The use of dual connectivity and conditional handover may require techniques for dual connectivity conditional handover.

### SUMMARY

According to a first aspect of the subject disclosure, a user equipment (UE) is presented that is configured to support operating in dual connectivity within at least one radio access network, RAN, and configured to support conditional handover, CHO. The user equipment comprises at least one processor and at least one memory including computer program code that causes the user equipment, when executed with the at least one processor, to establish a connection towards a primary cell of a source master node and to establish a connection towards a primary secondary cell of a source secondary node. The program code further causes the UE to receive a transmission indication from the source master node, wherein the transmission indication enables the user equipment to send a CHO execution indication via the source secondary node towards the source master node and to transmit the CHO execution indication via the source secondary node towards the source master node. Finally, the program code causes the UE to process CHO towards a primary cell of a target master node.

In embodiments, the transmission indication further configures the user equipment how to transmit the CHO execution indication via the source secondary node towards the source master node. In a further embodiment, the UE is configured to transmit the CHO execution indication via at least one of a signal radio bearer or a split bearer terminated at the source master node towards the source secondary node.

In further embodiments, the transmission indication is received as part of a Radio Resource Control, RRC, Reconfiguration message. In some embodiments, the transmission indication is received as part of a Radio Resource Control, RRC, Reconfiguration message that further comprises CHO configurations of at least one target primary cell of at least one target master node. In some embodiments, the transmission indication is received as part of a Radio Resource Control, RRC, Reconfiguration message exchanged during establishment of the connection with the source master node.

In further embodiments, the program code causes the UE further to receive, from the source master node, at least one CHO execution condition for CHO towards at least one target primary cell of at least one target master node, to perform measurements related to the received at least one CHO execution condition, and to, in response to at least one of the at least one CHO execution condition being fulfilled for the target master node based on the measurements, transmit the CHO execution indication via the source secondary node towards the source master node, wherein the CHO execution indication comprises a CHO execution condition fulfillment indication.

In related embodiments, the program code further causes the UE to, when transmitting the CHO execution condition fulfillment indication, maintain the connection towards at least the primary secondary cell of the source secondary node and, after transmitting the CHO execution condition fulfillment indication, terminate the connection towards the source master node for stopping data transmission and receipt. In some embodiments, the CHO execution condition fulfillment indication includes measurements related to the primary cell of the source master node and a primary cell of the target master node fulfilling the CHO execution condition. In some embodiments, the CHO execution condition fulfillment indication further includes measurements related to a plurality of cells being measured at the user equipment and available when the CHO execution condition is fulfilled.

In further embodiments, the CHO execution condition is received as part of a Radio Resource Control, RRC, message. In some embodiments, the CHO execution condition is included in the same message as at least one of the CHO transmission indication or CHO configurations of the at least one target primary cell of the at least one target master node. In some embodiments, the message used to transmit the CHO execution condition fulfillment indication further comprises an identification of the source master node.

In further embodiments, the program code further causes the UE to, in response to a determination of a radio link failure related to the connection towards the primary cell of the source master node, transmit the CHO execution indication via the source secondary node towards the source master node, wherein the CHO execution indication comprises a CHO recovery execution indication. In related embodiments, the program code further causes the UE to, in response to a determination that a radio link quality related to the connection towards the primary cell of the source master node starts to degrade according to at least one criterion, transmit measurements related to at least one potential target primary cell of at least one potential target master node via the source secondary node towards the source master node. In some embodiments, the at least one criterion comprises at least one threshold, and radio link quality degradation below threshold is determined while a timer for radio link failure detection is running or after receiving out-of-synch indications from lower layers.

According to a second aspect of the subject disclosure, a source master node configured to support establishing connection towards a user equipment configured to support operating in dual connectivity with a primary cell of the source master node and with a primary secondary cell of a source secondary node and supporting conditional handover, CHO, is presented. The source master node comprises at least one processor and at least one memory including computer program code causing the source master node, when executed with the at least one processor, to transmit a transmission indication to the user equipment, wherein the transmission indication enables the user equipment to send a CHO execution indication via the source secondary node towards the source master node and, in response to receiving the CHO execution indication from the source secondary node, to initiate data forwarding towards a primary cell of a target master node.

In embodiments, the transmission indication further configures the user equipment how to transmit the CHO execution indication via the source secondary node towards the source master node. In some embodiments, the transmission indication configures the user equipment to transmit the CHO execution indication via at least one of a signal radio bearer or a split bearer terminated at the source master node towards the source secondary node.

In further embodiments, the transmission indication is received as part of a Radio Resource Control, RRC, Reconfiguration message. In some embodiments, the transmission indication is received as part of a Radio Resource Control, RRC, Reconfiguration message which further comprises CHO configurations of at least one target primary cell of at least one target master node. In some embodiments, the transmission indication is received as part of a Radio Resource Control, RRC, Reconfiguration message exchanged during establishment of the connection with the source master node.

In further embodiments, the program code further causes the source master node to transmit at least one CHO execution condition for a conditional handover towards at least one target primary cell of at least one target master node and to receive the CHO execution indication from the source secondary node, wherein the CHO execution indication comprises a CHO execution condition fulfillment indication.

In related embodiments, the program code further causes the source master node to, in response to receiving the CHO execution condition fulfillment indication, terminate the connection towards the user equipment for stopping data transmission and receipt. In some embodiments, the CHO execution condition fulfillment indication includes measurements related to the primary cell of the source master node and a primary cell of the target master node fulfilling the CHO execution condition. In some embodiments, the CHO execution condition fulfillment indication further includes measurements related to a plurality of cells being measured at the user equipment and available when the CHO execution condition is fulfilled.

In further embodiments, the CHO execution condition is transmitted as part of a Radio Resource Control, RRC, message. In some embodiments, the CHO execution condition is included in the same message as at least one of the CHO transmission indication or CHO configurations of the at least one target primary cell of the at least one target master node. In some embodiments, the message used to transmit the CHO execution condition fulfillment indication further comprises an identification of the source master node.

In further embodiments, the program code further causes the source master node to receive the CHO execution indication from the source secondary node, wherein the CHO execution indication comprises a CHO recovery execution indication, wherein the CHO recovery execution indication is transmitted in response to a determination of a radio link failure related to the connection towards the primary cell of the source master node by the user equipment. In relates embodiments, the program code further causes the source master node to receive measurements related to at least one potential target primary cell of at least one potential target master node from the source secondary node, wherein the measurements are transmitted in response to a determination by the user equipment that a radio link quality related to the connection towards the primary cell of the source master node starts to degrade according to at least one criterion.

In some embodiments, the at least one criterion comprises at least one threshold, and radio link quality degradation below threshold is determined while a timer for radio link failure detection is running or after receiving out-of-synch indications from lower layers.

According to a third aspect of the subject disclosure, a network node that supports at least one of central unit control plane functionality or a layer 3 protocol of a radio access network, configured to support connection with a user equipment operating in dual connectivity with a primary cell of the network node and with a primary secondary cell of a source secondary node, and configured for conditional handover, CHO, is presented. The network node comprises at least one processor and at least one memory including computer program code causing the network node, when executed with the at least one processor, to generate a Radio Resource Control, RRC, message including a transmission indication, wherein the transmission indication enables the user equipment to send a CHO execution indication via the source secondary node to the network node, to transmit the Radio Resource Control, RRC, message including the transmission indication to the user equipment, and, in response to receiving the CHO execution indication in a Radio Resource Control, RRC, message from the source secondary node, to initiate data forwarding towards a primary cell of a target master node.

In embodiments, the network node is configured according to the source master node in related embodiments.

According to a fourth aspect of the subject disclosure, a method of conditional handover, CHO, performed by a user equipment configured to operate in dual connectivity within at least one radio access network, RAN, is presented. The method comprises establishing a connection towards a primary cell of a source master node, establishing a connection towards a primary secondary cell of a source secondary node, receiving a transmission indication, from the source master node, wherein the transmission indication enables the user equipment to send a CHO execution indication via the source secondary node towards the source master node, transmitting the CHO execution indication via the source secondary node towards the source master node, and processing CHO towards a primary cell of a target master node.

In embodiments, the transmission indication further configures the user equipment how to transmit the CHO execution indication via the source secondary node towards the source master node. In some embodiments, the method further comprises transmitting the CHO execution indication via at least one of a signal radio bearer or a split bearer terminated at the source master node towards the source secondary node.

In further embodiments, the transmission indication is received as part of a Radio Resource Control, RRC, Reconfiguration message. In some embodiments, the transmission indication is received as part of a Radio Resource Control, RRC, Reconfiguration message which further comprises CHO configurations of at least one target primary cell of at least one target master node. In some embodiments, the transmission indication is received as part of a Radio Resource Control, RRC, Reconfiguration message exchanged during establishment of the connection with the source master node.

In further embodiments, the method further comprises receiving, from the source master node, at least one CHO execution condition for CHO towards at least one target primary cell of at least one target master node, performing measurements related to the received at least one CHO execution condition, and, in response to at least one of the at least one CHO execution condition being fulfilled for the target master node based on the measurements, transmitting the CHO execution indication via the source secondary node towards the source master node, wherein the CHO execution indication comprises a CHO execution condition fulfillment indication.

In related embodiments, the method further comprises, when transmitting the CHO execution condition fulfillment indication, maintaining the connection towards at least the primary secondary cell of the source secondary node for continued data transmission and receipt, and, after transmitting the CHO execution condition fulfillment indication, terminating the connection towards the primary cell of the source master node. In some embodiments, the CHO execution condition fulfillment indication includes measurements related to the primary cell of the source master node and a primary cell of the target master node fulfilling the CHO execution condition. In some embodiments, the CHO execution condition fulfillment indication further includes measurements related to a plurality of cells being measured at the user equipment and available when the CHO execution condition is fulfilled.

In embodiments, the CHO execution condition is received as part of a Radio Resource Control, RRC, message. In some embodiments, the CHO execution condition is included in the same message as at least one of the CHO transmission indication or CHO configurations of the at least one target primary cell of the at least one target master node. In some embodiments, the message used to transmit the CHO execution condition fulfillment indication further comprises an identification of the source master node.

In further embodiments, the method further comprises, in response to a determination of a radio link failure related to the connection towards the primary cell of the source master node, transmitting the CHO execution indication via the source secondary node towards the source master node, wherein the CHO execution indication comprises a CHO recovery execution indication. In relates embodiments, the method further comprises, in response to a determination that a radio link quality related to the connection towards the primary cell of the source master node starts to degrade according to at least one criterion, transmitting measurements related to at least one potential target primary cell of at least one potential target master node via the source secondary node towards the source master node. In some embodiments, the at least one criterion comprises at least one threshold, and radio link quality degradation below threshold is determined while a timer for radio link failure detection is running or after receiving out-of-synch indications from lower layers.

According to a fifth aspect of the subject disclosure, a method of conditional handover, CHO, performed by a source master node connected with a user equipment operating in dual connectivity with a primary cell of the source master node and with a primary secondary cell of a source secondary node, is presented. The method comprises transmitting a transmission indication to the user equipment, wherein the transmission indication enables the user equipment to send a CHO execution indication via the source secondary node towards the source master node and, in response to receiving the CHO execution indication from the source secondary node, initiating data forwarding towards a primary cell of a target master node.

In embodiments, the transmission indication further configures the user equipment how to transmit the CHO execution indication via the source secondary node towards the source master node. In some embodiments, the transmission indication configures the user equipment to transmit the CHO execution indication via at least one of a signal radio bearer or a split bearer terminated at the source master node towards the source secondary node.

In further embodiments, the transmission indication is received as part of a Radio Resource Control, RRC, Reconfiguration message. In some embodiments, the transmission indication is received as part of a Radio Resource Control, RRC, Reconfiguration message which further comprises CHO configurations of at least one target primary cell of at least one target master node. In some embodiments, the transmission indication is received as part of a Radio Resource Control, RRC, Reconfiguration message exchanged during establishment of the connection with the source master node.

In further embodiments, the method further comprises transmitting at least one CHO execution condition for a conditional handover towards at least one target primary cell of at least one target master node, and receiving the CHO execution indication from the source secondary node, wherein the CHO execution indication comprises a CHO execution condition fulfillment indication. In some embodiments, the method further comprises, in response to receiving the CHO execution condition fulfillment indication, terminating the connection towards the primary cell of the source master node. In some embodiments, the CHO execution condition fulfillment indication includes measurements related to the primary cell of the source master node and a primary cell of the target master node fulfilling the CHO execution condition. In some embodiments, the CHO execution condition fulfillment indication further includes measurements related to a plurality of cells being measured at the user equipment and available when the CHO execution condition is fulfilled.

In further embodiments, the CHO execution condition is transmitted as part of a Radio Resource Control, RRC, message. In some embodiments, the CHO execution condition is included in the same message as at least one of the CHO transmission indication or CHO configurations of the at least one target primary cell of the at least one target master node. In some embodiments, the message used to transmit the CHO execution condition fulfillment indication further comprises an identification of the source master node.

In further embodiments, the method further comprises receiving the CHO execution indication from the source secondary node, wherein the CHO execution indication comprises a CHO recovery execution indication, wherein the CHO recovery execution indication is transmitted in response to a determination of a radio link failure related to the connection towards the primary cell of the source master node by the user equipment. In related embodiments, the method further comprises receiving measurements related to at least one potential target primary cell of at least one potential target master node from the source secondary node, wherein the measurements are transmitted in response to a determination by the user equipment that a radio link quality related to the connection towards the primary cell of the source master node starts to degrade according to at least one criterion. In some embodiments, the at least one criterion comprises at least one threshold, and radio link quality degradation below threshold is determined while a timer for radio link failure detection is running or after receiving out-of-synch indications from lower layers.

The above-noted aspects and features may be implemented in systems, apparatuses, methods, articles and non-transitory computer-readable media depending on the desired configuration. The subject disclosure may be implemented in and used with a number of different types of devices, including but not limited to cellular phones, tablet computers, wearable computing devices, portable media players, and any of various other computing devices.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings and claims.

### LIST OF ABBREVIATIONS

In the subject disclosure, the following abbreviations are used and should be understood in accordance with the given definitions:
3 3^{rd} Generation Partnership Project
5G 5^{th} Generation (Mobile Communication Network)
5GC 5G Core Network
NG-RAN Next-Generation Radio Access Network
NR New Radio, 5G
LTE Long-Term Evolution, 4G
BS Base Station
UE User Equipment
HO Handover
CHO Conditional Handover
DC Dual Connectivity
gNB gNodeB (NR)
eNB eNodeB (LTE)
SCG Secondary Cell Group
MCG Master Cell Group
PCell Primary Cell
PSCell Primary Secondary Cell
MN Master/Main Node
SN Secondary Node
RRC Radio Resource Control Reconfiguration
SRB Signaling Radio Bearer
gNB-CU-CP gNodeB Central Unit Control Plane
gNB-CU-UP gNodeB Central Unit User Plane
gNB-DU gNodeB Distributed Unit
AMF Access and Mobility Function
UPF User Plane Function

### BRIEF DESCRIPTION OF THE DRAWINGS

A better understanding of the subject disclosure can be obtained when the following detailed description of various embodiments is considered in conjunction with the following drawings, in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIGS. 4A and 4B depict an NG-RAN architecture;

FIG. 5 presents a flow chart for dual connectivity conditional handover with on-time data forwarding performed by a user equipment;

FIG. 6 presents a flow chart for dual connectivity conditional handover with on-time data forwarding performed by a source master node;

FIG. 7 presents a flow chart for dual connectivity conditional handover with on-time data forwarding performed by a control plane central unit of a source base station;

FIG. 8 shows a message flow diagram of an exemplary overall dual connectivity conditional handover; and

FIG. 9 shows a message flow diagram of an exemplary overall dual connectivity conditional handover for conditional handover recovery.

### DETAILED DESCRIPTION

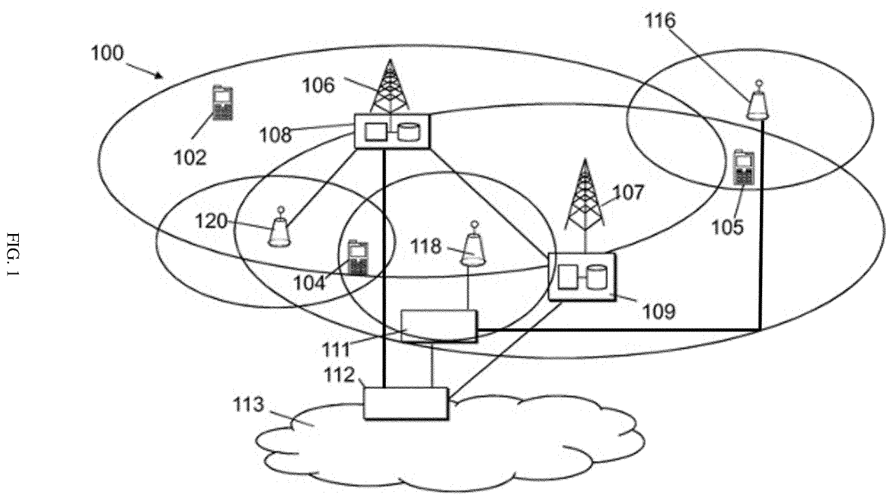

Before explaining the examples in detail, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices, user devices, User Equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communication devices in communication with the base stations. The controller apparatus may be located in a Radio Access Network (RAN) (e.g., wireless communication system 100) or in a Core Network (CN) (not shown) and may be implemented as one central apparatus or its functionality may be distributed over several apparatuses. The controller apparatus may be part of the base station and/or provided by a separate entity such as a Radio Network Controller (RNC). In FIG. 1, control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in the RNC.

In FIG. 1, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various Radio Access Technologies (RATs), also referred to as wireless communication technologies, or telecommunication standards described hereinbelow. As illustrated in FIG. 1, while one of the base stations may act as a “serving cell” for UEs, an UE may also be capable of receiving signals from (and possibly within communication range of) one or more other cells (which might be provided by the base stations and/or any other base stations), which may be referred to as “neighboring cells”.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, Wireless Local Area Network (WLAN) and may be WLAN Access Points (APs). The communication devices 102, 104, 105 may access the communication system based on various access techniques, such as Code Division Multiple Access (CDMA), or Wideband CDMA (WCDMA). Other non-limiting examples comprise Time Division Multiple Access (TDMA), Frequency Division Multiple Access (FDMA) and various schemes thereof such as the Interleaved Frequency Division Multiple Access (IFDMA), Single Carrier Frequency Division Multiple Access (SC-FDMA) and Orthogonal Frequency Division Multiple Access (OFDMA), Space Division Multiple Access (SDMA) and so on.

An example of wireless communication systems are architectures standardized by the 3rd Generation Partnership Project (3GPP). A latest 3GPP based development is often referred to as the Long-Term Evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (or LTE-A) employs a radio mobile architecture known as the Evolved Universal Terrestrial Radio Access Network (E-UTRAN) and a Core Network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as WLAN and/or Worldwide interoperability for Microwave access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QOS) support, and some on-demand requirements for QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize Network Functions Virtualization (NFV) which is a network architecture concept that proposes virtualizing network node functions into “building blocks” or entities that may be operationally connected or linked together to provide services. A Virtualized Network Function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G Core Network (CN) comprises functional entities. The CN is connected to a UE via the Radio Access Network (RAN). A User Plane Function (UPF) whose role is called PDU Session Anchor (PSA) may be responsible for forwarding frames back and forth between the Data Network (DN) and the tunnels established over the 5G towards the UEs exchanging traffic with the DN.

The UPF is controlled by a Session Management Function (SMF) that receives policies from a Policy Control Function (PCF). The CN may also include an Access and Mobility Function (AMF).

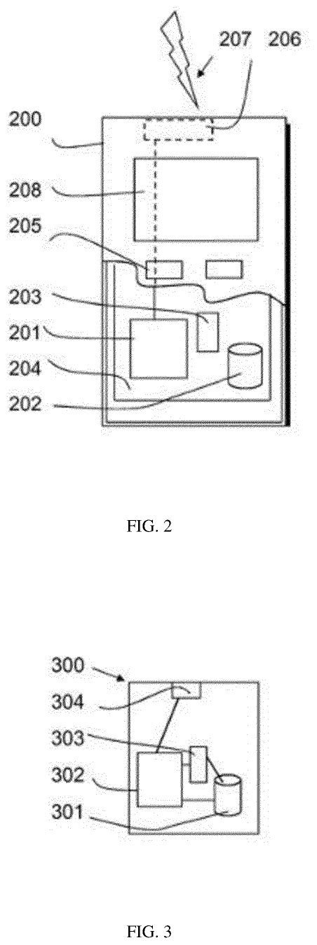

A possible (mobile) communication device 200 will now be described in more detail with reference to FIG. 2 showing a schematic, partially sectioned view. Such a mobile communication device 200 is often referred to as User Equipment (UE), user device or terminal device. An appropriate mobile communication device 200 may be provided by any device capable of sending and receiving radio signals. Non-limiting examples comprise a Mobile Station (MS) or mobile device such as a mobile phone or what is known as a smart phone, a computer provided with a wireless interface card or other wireless interface facility (e.g., USB dongle), Personal Data Assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more Global Navigational Satellite Systems (GNSS such as GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be (communicatively) coupled (e.g., directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an Application Specific Integrated Circuit (ASIC), a Field Programmable Gate Array (FPGA), and/or the like, or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11 , 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various 3^{rd} Generation (3G) communication protocols, 4^{th} generation (4G) communication protocols, 5th Generation (5G) communication protocols, Internet Protocol Multimedia Subsystem (IMS) communication protocols such as, for example, Session Initiation Protocol (SIP) and/or the like, or 5G beyond. For example, the communication device 200 may be capable of operating in accordance with 4G wireless communication protocols, such as LTE-A, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder, an internal data modem, and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as Wireless Application Protocol (WAP), HyperText Transfer Protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless Universal Serial Bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or WLAN modem may also be capable of transmitting and/or receiving data from electronic devices according to various wireless networking techniques, including 6LoWPAN, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more Embedded Universal Integrated Circuit Cards (eUICCs), one or more Universal Integrated Circuit Cards (UICC), and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 2, computer-readable medium may comprise a non-transitory computer-readable storage medium that may be any media that can contain or store the instructions for use by or in connection with an instruction execution system, apparatus, or device, such as a computer.

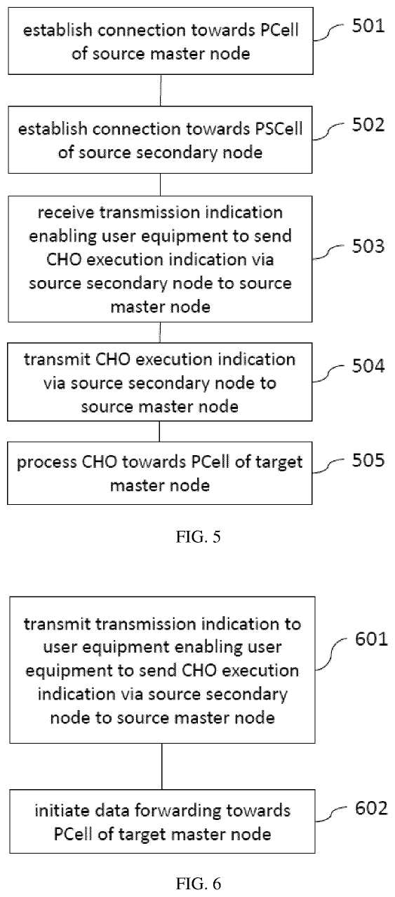

In some embodiments, the communication device 200 (i.e., UE or a user device in a network) comprises the processor (e.g., the at least one data processing entity 201) and the memory (e.g., the at least one memory 202). The memory includes computer program code causing the communication device 200 to perform processing according to the methods described below with reference to FIG. 5.

FIG. 3 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as an RNC or a spectrum controller. In some embodiments, an base station may have such a control apparatus as well as a control apparatus being provided in an RNC. The control apparatus 300 can be arranged to provide control on communications in the service area of the system. The control apparatus 300 comprises at least one memory 301, at least one data processing unit 302, 303 and an input/output interface 304. Via the interface the control apparatus 300 can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. A processor processes the received baseband signals and invokes different functional modules to perform features in control apparatus 300. Memory (e.g., the at least one memory 301) stores program instructions and data to control the operations of the control apparatus 300. In the example of FIG. 3, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more micro-processor associated with a DSP core, a controller, a microcontroller, ASICs, FPGA circuits, and other type of integrated circuits (ICs), and/or state machines.

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIG. 6.

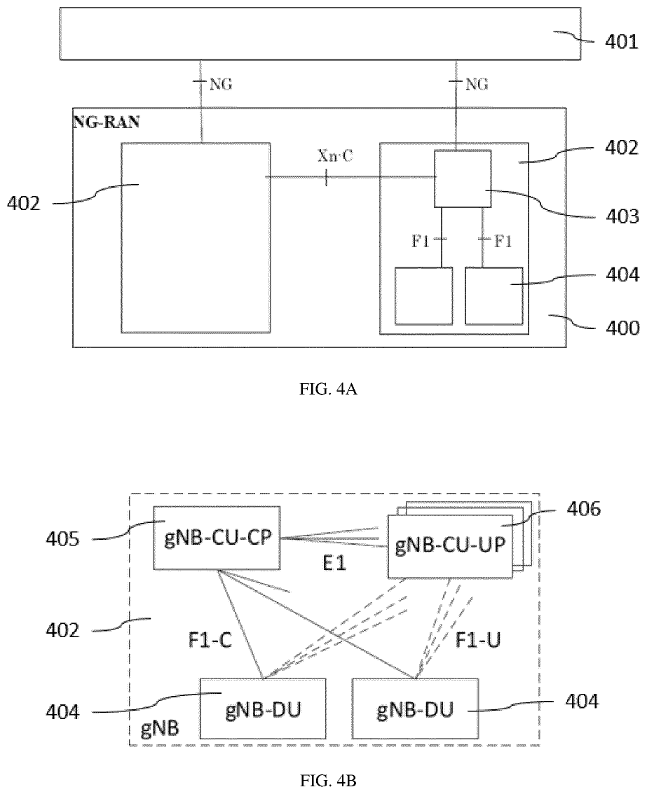

FIGS. 4A and 4B depict a next-generation radio access network (NG-RAN) architecture 400 with gNBs 402 according to 3 GPP TS 38.401V17.0.0. A gNB 402 employs NR user/control plane protocols to serve UEs and is connected to the 5GC 401 via the NG interface and to other gNBs 402 through Xn interface. The gNB 402 of FIG. 4A comprises a central unit (i.e., gNB-CU) 403 and one or more distributed units (i.e., gNB-DU) 404. The gNB-CU is a logical node hosting RRC, SDAP and PDCP protocols of the gNB or RRC and PDCP protocols of the en-gNB that controls the operation of one or more gNB-DUs 404. The gNB-CU 403 terminates the F1 interface connected with the gNB-DU 404. The dNB-DU 404 is a logical node hosting RLC, MAC and PHY layers of the gNB 402 or en-gNB, and its operation is partly controlled by gNB-CU 403. One gNB-DU 404 supports one or multiple cells. One cell is supported by one gNB-DU 404. The gNB-DU 404 terminates the F1 interface connected with the gNB-CU 403.

One gNB-DU 404 is connected to one gNB-CU 403 via F1 interface. NG, Xn, and F1 are logical interfaces. The Xn-C interface interconnects gNB-CUs 403 of different gNBs 402. The gNB 402 can also comprise a gNB-CU control-plane (gNB-CU-CP), multiple gNB-CU user-plane (gNB-CU-UPs), and multiple gNB-DUs, which are depicted in more detail in FIG. 4B.

It should be noted that NG-RAN could also comprise a set of ng-eNBs, an ng-eNB may comprise an ng-eNB-CU and one or more ng-eNB-DU(s). An ng-eNB-CU and an ng-eNB-DU is connected via W1 interface.

FIG. 4B illustrates the architecture with separation of the control plane and the user plane for the gNB-CU (i.e., gNB-CU-CP and gNB-CU-UP) 403. The gNB-CU-CP 405 is a logical node hosting the RRC and the control plane part of the PDCP protocol of the gNB-CU 403 for an en-gNB or a gNB 402. The gNB-CU-CP 405 terminates the El interface connected with the gNB-CU-UP 406 and the F1-C interface connected with the gNB-DU 404. The gNB-CU-UP 406 is a logical node hosting the user plane part of the PDCP protocol of the gNB-CU 403 for an en-gNB, and the user plane part of the PDCP protocol and the SDAP protocol of the gNB-CU 403 for a gNB 402. The gNB-CU-UP 406 terminates the El interface connected with the gNB-CU-CP 405 and the F1-U interface connected with the gNB-DU 404. The gNB-CU-UP 406 is connected to one gNB-CU-CP 405, to multiple gNB-CU-UPs 406 and multiple gNB-DUs 404 under the control of the same gNB-CU-CP 405.

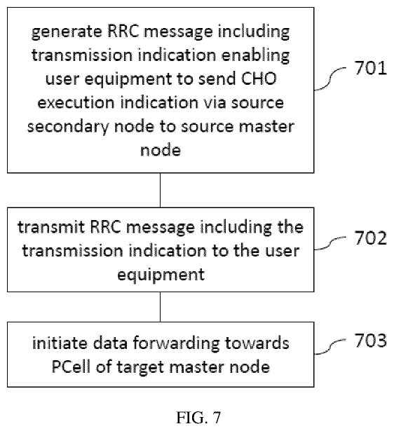

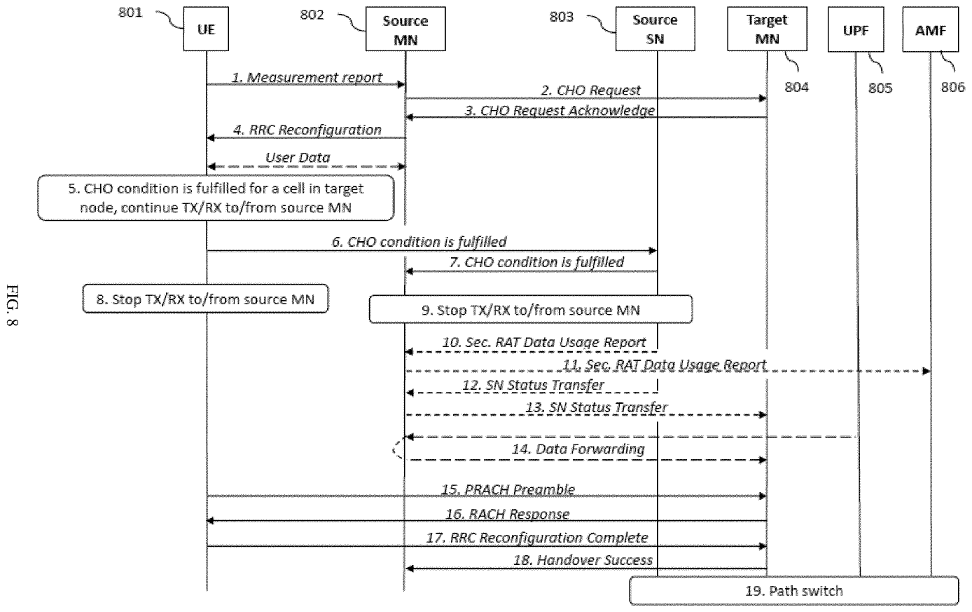

In some embodiments, the gNB-CU-CP 405 is associated to a processor and a memory. The memory includes computer program code causing the gNB supporting the functionality of gNB-CU-CP 405 to perform processing according to the method described below with reference to FIG. 7.

The following description may provide further details of alternatives, modifications and variances: a gNB may comprise, e.g., a node providing NR user plane and control plane protocol terminations towards the UE, and connected via the NG interface to the 5GC, e.g., according to 3GPP TS 38.300 V17.0.0 incorporated herein by reference.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU. A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the El interface connected with the gNB-CU-UP and the F1-C interface connected with the gNB-DU. A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the El interface connected with the gNB-CU-CP and the F1-U interface connected with the gNB-DU, e.g., according to 3GPP TS 38.401V17.0.0, section 3.1 incorporated herein by reference.

Different functional splits between the central and distributed unit are possible, e.g. called options: Option 1 (1A-like split), in which the function split is similar to the 1A architecture in DC. RRC is in the central unit. PDCP, RLC, MAC, physical layer and RF are in the distributed unit. Option 2 (3C-like split), in which the function split is similar to the 3C architecture in DC. RRC and PDCP are in the central unit. RLC, MAC, physical layer and RF are in the distributed unit. Option 3 (intra RLC split), in which low RLC (partial function of RLC), MAC, physical layer, and RF are in the distributed unit. PDCP and high RLC (the other partial function of RLC) are in the central unit. Option 4 (RLC-MAC split), in which MAC, physical layer, and RF are in the distributed unit. PDCP and RLC are in the central unit. Or else, e.g., according to 3GPP TR 38.801V14.0.0, section 11 incorporated by reference.

A gNB supports different protocol layers, e.g., Layer 1 (L1)-physical layer. The layer 2 (L2) of NR is split into the following sublayers: Medium Access Control (MAC), Radio Link Control (RLC), Packet Data Convergence Protocol (PDCP), and Service Data Adaptation Protocol (SDAP), The physical layer may offer to the MAC sublayer transport channels; the MAC sublayer may offer to the RLC sublayer logical channels, the RLC sublayer may offer to the PDCP sublayer RLC channels, the PDCP sublayer may offer to the SDAP sublayer radio bearers, and the SDAP sublayer may offer to 5GC QoS flows. Control channels include, e.g., BCCH, PCCH. Layer 3 (L3) includes, e.g., Radio Resource Control (RRC), e.g. according to 3GPP TS 38.300V17.0.0, section 6 incorporated herein by reference.

A RAN (Radio Access Network) node or network node like a gNB, base station, gNB-CU, or gNB-DU. or parts thereof may be implemented using, e.g., an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB-CU and gNB-DU parts may, e.g., be co-located or physically separated. The gNB-DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. A gNB-DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g., according to 3GPP TS 38.331V17.0.0, sections 4.2.1 and 4.4, incorporated herein by reference). A UE is, e.g., either in RRC CONNECTED state or in RRC INACTIVE state when an RRC connection has been established. In RRC CONNECTED state a UE may store the AS context, transfer unicast data to/from the UE, monitor control channels associated with the shared data channel to determine if data is scheduled for the data channel, provide channel quality and feedback information, and/or perform neighboring cell measurements and measurement reporting. The RRC protocol includes, e.g., the following main functions: RRC connection control, measurement configuration and reporting, establishment/modification/release of measurement configuration (e.g. intra-frequency, inter-frequency and inter-RAT measurements), setup and release of measurement gaps, and/or measurement reporting.

Before referring to FIGS. 5 to 8 and describing the of dual connectivity conditional handover with on-time data forwarding according to some embodiments of the subject disclosure, some background information and aspects related to the subject disclosure will be provided.

For example, the subject disclosure may be incorporated in a network that may dual connectivity and conditional handover (CHO). CHO procedure has been introduced in 3GPP specifications of release 16 to improve the mobility robustness. In case of CHO (e.g., as described in 3GPP TS 38.300V17.0.0, section 9.2.3.4), the network may prepare multiple target cells where conditional handover reconfiguration is associated with a CHO execution condition that is evaluated by the UE. The CHO execution condition refers to a measurement ID (associating a measurement object with a reporting configuration) that is configured by source gNB. The reporting configuration defines the measurement event (e.g., measurement events A3 or A5 as defined in the 3GPP TS 38.311V17.0.0, sections 5.5.4.4 and 5.5.4.6), which triggers the CHO execution. Whenever CHO execution condition is met, the corresponding target configuration is selected and handover including data forwarding from the source master node to at least a target master node is executed.

Additionally, CHO recovery—or in other words RRC re-establishment with using CHO configurations—has been introduced in 3GPP specifications of release 16 to reduce the interruption time caused by failures for UEs that are configured with conditional reconfigurations for multiple target cells. The CHO recovery mechanism (e.g., as described in 3GPP TS 38.311V17.0.0, section 5.3.7.3) allows UE that detects a radio link failure to recover on a cell with stored CHO configuration. Whenever radio link failure is detected and a CHO configuration of at least one suitable cell is available, the UE selects the corresponding target configuration and handover including data forwarding from the source master node to at least a target master node is executed.

Currently, there are two type of data forwarding defined that the network can perform in this procedure, i.e., late data forwarding and early data forwarding.

In the example of late data forwarding, the process of CHO as currently defined in the 3GPP standards is the following. First, the UE is served by a primary cell (PCell) in a source master node (MN) and a primary secondary cell (PSCell) in source secondary node (SN), i.e., the primary cell of the secondary node. UE sends the measurement report to its serving PCell to initiate the CHO preparation of a PCell in target MN. Source PCell prepares the target PCell and sends UE the CHO preparation along with the CHO execution condition in RRC Reconfiguration message. Once the CHO execution condition against target PCell is met, UE detaches from source PCell, i.e., stops data transmission/reception (TX/RX) to/from source PCell. Then, the UE initiates random access procedure towards target PCell. Once the random access procedure is completed successfully, target PCell of target MN notifies source PCell of source MN about successful completion of handover procedure. Upon receiving the handover success indication from target MN, source PCell in source MN initiates the data forwarding to target PCell of target MN. Similarly, the source PSCell in source SN can initiate the data forwarding once it receives an indication (e.g. SN Release Request) from the source MN. Once the data forwarding procedure is completed, UE will continue its data transmission/reception with the network.

Similarly, in the example of early data forwarding, the source PCell in MN and the source PSCell in source SN can initiate the data forwarding towards target PCell/PSCell once the CHO preparation is completed.

Late data forwarding and early data forwarding may both lead to issues. For example, in the case of late data forwarding, when the UE detaches from the source PCell, it will stop TX/RX to/from the source PCell and continues its data connection once the data forwarding is completed between source and target PCell. During this time, the UE experiences an interruption.

In the case of early data forwarding, for example, data forwarding until CHO execution condition is met is in-vain for the prepared target cells that the UE did not access. In CHO, the time elapsed between CHO preparation and execution towards a target cell can be hundreds of milliseconds, depending on the preparation and execution conditions. During this period of time, the source PCell performs data forwarding towards prepared target cells. The data received by the target PCell is buffered by the target PCell until the UE completes the CHO execution towards target PCell successfully. This also means that the target PCell might discard the packets which are transmitted by source PCell to the UE upon receiving an Early SN Status transfer message from source PCell.

The resource waste problem of early data forwarding is more pronounced when there are multiple target PCells prepared by the same source PCell, i.e., the source PCell will do early data forwarding towards all prepared target PCells since the source PCell does not know towards which target PCell the UE will execute the CHO. It should be further noted that in case PSCells are prepared together with the PCells data has to be forwarded to the SN as well, resulting in further resource waste.

Therefore, in the case of late data forwarding, the UE will experience user data interruption (after CHO execution) until the data forwarding between source PCell and target PCell is started. In the case of early data forwarding, the source PCell should carry out data forwarding to all prepared target cells which leads to significant signaling overhead on the network until the UE executes CHO towards one of the prepared cells.

To overcome these issues, an additional message indicating that the UE stops communication with the source PCell sent to the source PCell may be an option for CHO or for CHO recovery. However, since it cannot be ensured that the radio link between the UE and source PCell will be stable once the UE decides to switch to the target cell since the link may not be good enough to send such message to source PCell, when the UE performs handover. Hence the benefits are questionable.

Therefore, a solution is presented that sends a “CHO execution indication” message which overcomes the above-mentioned issues and does not rely on a stable connection to the source MN. Transmitting this message via the source SN to the source MN takes advantage of dual connectivity, in which the UE operates, to indicate the CHO execution to MN via SN whose radio link quality is sufficient given that the decision to change the source SN is not taken by the network but CHO execution concerns changing MNs.

The herein proposed methods and apparatuses of dual connectivity conditional handover and/or CHO recovery allows on-time data forwarding from source PCell (MN)/source PSCell (SN) to target PCell/PSCell when CHO from source PCell to target PCell is executed in the presence of active dual-connectivity (DC), i.e., UE is served by both source PCell of source MN and source PSCell of source SN.

To make use of the connection of the UE to MN and SN, the CHO execution indication is forwarded to source MN from source SN or, more generally, transmitted to the source MN via source SN. Furthermore, the UE does not break the connection with source SN when CHO execution condition is met. The UE sends a CHO execution indication, e.g., a CHO execution condition fulfillment indication or a CHO recovery execution indication, to source SN. The UE disconnects from source MN (and in some embodiment also from source SN) after CHO execution indication to source SN is sent, and the UE initiates the CHO execution afterwards, e.g., starts a handover random access procedure with a target MN. Source SN relays the CHO execution condition fulfillment indication to source MN and source MN and source SN initiate the on-time data forwarding towards target MN/SN.

A flow chart for dual connectivity conditional handover with on-time data forwarding performed by a UE is presented in FIG. 5. The user equipment comprises at least one processor and at least one memory including computer program code that causes the UE to execute the processes described herein. In other words, the UE is configured to execute the processes described herein.

The UE configured for operating in dual connectivity, i.e., it may be connected with a source base station as master node, also referred to a source MIN, and a secondary base station, also referred to as source SN or SN. The processes described with respect to FIG. 5 are-except of the first two processes of establishing connections-generally executed during conditional handover, e.g., during or at the end of conditional handover preparation for switching from source MN to a target base station that is then connected as master node, also referred to as target MN. For example, the source MN may have determined-e.g., based on measurements performed and reported by the UE in a measurement report-that a conditional handover with one or more target MN is to be expected. Afterwards, the source MN may have sent a CHO request to one or more target MN. The one or more (or at least some of those) target MN may have acknowledged the CHO request. In future communication systems, other steps may also possible to be performed before the processes described with respect to FIG. 5 are executed.

Starting with box 501, the UE establishes a connection towards a PCell of a source MN. The UE also establishes a connection towards a PSCell of a source SN as shown in box 502. For example, after being powered on, the UE may first establish a connection towards a PCell of a source MN according to measurements. Thereafter, the UE may also establish a connection towards a PSCell of another base station that then serves as source SN in order to apply dual connectivity. Of course, the UE may also establish the connections to the two nodes in another order. For example, the UE may perform an MN handover so that it keeps the PSCell of its current source SN and establishes a new connection to the PCell of the handover target MN. Hence, boxes 501 and 502 are required to ensure that the UE is operating in dual connectivity but may be performed in any order or at any time.

In box 503, the UE receives a transmission indication that enables the UE to transmit a CHO execution indication via the source SN to the source MN. The transmission indication may also configure the UE how to transmit the CHO execution indication via the source SN to the source MN.

For example, the transmission indication may configure the UE to transmit the CHO execution indication via a signal radio bearer, e.g., SRB3 to the SN. In this example, the UE sends the CHO execution indication to the SN via SRB3 and SN relays this information to source MN. The MN may then initiate on-time data forwarding. In another example, the transmission indication may configure the UE to transmit the CHO execution indication via a split bearer. In this example, the UE is configured to send CHO execution condition fulfillment indication to source MN via a MN-terminated SN bearer.

The transmission indication may be transmitted as RRC message. In an embodiment, the transmission indication may be received as part of a Radio Resource Control, RRC, Reconfiguration message exchanged during establishment of the connection with the source MN. As another network implementation, an RRC message, e.g., RRC reconfiguration, triggering the herein described dual connectivity CHO can be used to configure the split SRB or SRB3 bearer to allow forwarding of CHO execution indication to the source MN. The RRC message carrying the transmission indication may in one embodiment also comprise CHO configurations of at least one target PCell of at least one target MN.

When the UE is configured to transmit the CHO execution indication via the source SN to the source MN, it will send the send the CHO execution indication as configured, which is depicted in box 504. The CHO execution indication may be sent in response to a condition being fulfilled, e.g., a condition that triggers a regular handover to a target MN or a cell re-establishment due to a radio link failure. Finally and shown in box 505, after sending the CHO execution indication, the UE processes a conditional handover (e.g., a regular CHO or a CHO recovery) towards a PCell of the target MN.

In an example embodiment concerning the application of the herein presented method and apparatuses for on-time data forwarding in DC-CHO, the UE is further configured to receive, from the source MN, at least one CHO execution condition for CHO towards at least one target primary cell of at least one target master node. A CHO execution condition defines which conditions shall be fulfilled for performing CHO towards the target MN. If the UE receives a plurality of CHO execution conditions of a plurality of target MNs, these CHO execution conditions may be transmitted to the UE in one message, such as an RRC Reconfiguration message. Alternatively, the CHO execution conditions may be transmitted in at least two separate messages. Instead of using an RRC Reconfiguration message, other messages of layer 2 or 1, such as MAC signaling or signaling the CHO execution condition via PDCCH, may be used.

In this example embodiment, the UE may also be configured to perform measurements related to the received at least one CHO execution condition. For example, the UE may measure specific connection specific values, such as the synchronized signals (SSs) and/or channel state information reference signals (CSI-RSs) from the source MN and the target MN. Based on the measurements, the UE may decide whether the CHO execution condition of the target MN is fulfilled. If so, the UE may transmit a CHO execution condition fulfillment indication via the SN to the source MN. In one example, the UE may maintain the connection towards the source MN, i.e., the UE may not stop communication with source MN when it determines that the CHO execution condition is fulfilled but only stops communication after sending the CHO execution condition.

In response to at least one of the at least one CHO execution condition being fulfilled for the target master node based on the measurements, the UE may then be configured to transmit the CHO execution indication via the source SN to the source MN, wherein the CHO execution indication comprises a CHO execution condition fulfillment indication. The CHO execution condition fulfillment indication comprises indication(s) about fulfillment of the CHO execution condition(s).

In one embodiment, the CHO execution condition fulfillment indication includes measurements related to a PCell of the source MN and/or a PCell of the target MN fulfilling the CHO execution condition. For example, the CHO execution condition fulfillment indication includes UE measurements related to the source PCell and/or target PCell that satisfy the CHO execution condition. In another embodiment, the CHO execution condition fulfillment indication further or alternatively includes measurements related to a plurality of cells being measured and available at the user equipment when the CHO execution condition is fulfilled. In this example, measurements for PSCells may also be included.

The CHO execution condition may be included in an RRC message. In one embodiment, this RRC message may be the same RRC message that carries the transmission indication and/or the CHO conditions of the at least one target MN. Additionally or alternatively, the CHO execution condition fulfillment indication may comprise an identification of the source MN, e.g., to enable forwarding of the message to the source MN.

Additionally or alternatively, the UE may be configured by the RRC message to report measurements related to a plurality of cells being measured and available at the user equipment when the CHO execution condition is fulfilled as described above. Additionally or alternatively, the measurement configuration configures the UE to report measurements related to a primary cell of the source SN and/or a primary cell of the target SN fulfilling the CHO execution condition as described above.

In another example embodiment concerning the application of the herein presented method and apparatuses for on-time data forwarding in DC-CHO, the UE may be configured to transmit the CHO execution indication via the source secondary node towards the source master node, in response to a determination of a radio link failure related to the connection towards the primary cell of the source master node. In this example, the CHO execution indication comprises a CHO recovery execution indication. As the skilled person will understand, the general process of transmitting a message via the source SN to the source MN in order to ensure an on-time data forwarding in this example is mainly the same as in the other example, wherein the CHO execution indication comprises a CHO execution condition fulfillment indication. Both embodiments may be implemented together in a UE or separately.

In one example of the CHO recovery embodiment, the UE may be configured to transmit measurements related to at least one potential target primary cell of at least one potential target master node via the source secondary node towards the source master node, in response to a determination that a radio link quality related to the connection towards the primary cell of the source master node starts to degrade according to at least one criterion. The criterion may comprise relate to a running timer for radio link failure detection, e.g., the timer being below a threshold, or receiving out-of-synch indications from lower layers.

The UE may be configured to report the measurements by an RRC message, e.g., the RRC message that is used to configure the UE for CHO, in particular, for CHO recovery. For example, the RRC message, e.g., RRC reconfiguration message, may comprise measurement configuration that configures the UE to report, e.g., along with the CHO execution condition fulfillment indication or in another message, measurements related to at least one potential primary cell of the target base station and/or of at least one potential primary secondary cell of the secondary base station when a radio link quality related to the connection towards the primary cell of the source base station starts to degrade. These measurements enable on-time data forwarding for CHO recovery.

For example, before detecting radio link failure on source MN (e.g., while a timer, such as timer T310, for radio link failure detection is running or out-of-sync indications are received from lower layers), the UE may indicate, e.g., with the CHO execution condition fulfillment indication the best target PCells (with highest measurements) to source SN which in turn relays this information to source MN. Using this information, the source MN and source SN can start data forwarding to potential target cells among which the UE might select one cell for CHO recovery (which is triggered after failure detection).

After transmitting the CHO execution indication via the SN, the UE may terminate communication with source MN and start handover random access procedure with target MN. Hence, the UE may inform the source MN via the SN that it will start a CHO procedure with the target MN while still being in communication with the source MN. This enables data transmissions to be finished before the UE stops communication with source MN and starts random access with target MN. Moreover, this enables the source MN to know when and to which target MN the data forwarding during handover shall take place. Moreover, since the CHO execution indication is transmitted via the SN, the source MN will-even if the connection quality to the source MN is not sufficient for direct transmission-receive the information about CHO execution indication.

The UE may also comprise means for performing the processes described herein. For example, the UE may comprise means for establishing a connection towards a primary cell of a source master node and means for establishing a connection towards a primary secondary cell of a source secondary node. The UE may further comprise means for receiving a transmission indication from the source master node, wherein the transmission indication enables the user equipment to send a CHO execution indication via the source secondary node towards the source master node and means for transmitting the CHO execution indication via the source secondary node towards the source master node. Finally, the UE may comprise means for processing CHO towards a primary cell of a target master node. Means for the other herein described processes may be provided as well.

A flow chart for dual connectivity conditional handover with on-time data forwarding performed by a source MN is presented in FIG. 6. The source MN comprises at least one processor and at least one memory including computer program code that causes the source MN to execute the processes described herein. In other words, the source MN is configured to execute the processes described herein.

The source MN is connected as master node with a UE that is configured to operate in dual connectivity and is configured to execute the processes depicted in FIG. 6 during CHO. For example, before executing the processes of FIG. 6, the source MN may have determined e.g., based on measurements performed and reported by the UE in a measurement report-that a conditional handover with one or more target MN is to be expected. Afterwards, the source MN may have sent a CHO request to one or more target MN based on information provided in the measurement report. The one or more (or at least some of those) target MN may have then acknowledged the CHO request. It shall be noted that in future communication systems, the conditional handover preparation may comprise difference processes that are executed before the processes described with respect to FIG. 6.

Starting with box 601, the source MN transmits a transmission indication to the UE, wherein the transmission indication enables the user equipment to send a CHO execution indication via the source SN to the source MN. The transmission indication may also configure the UE how to transmit the CHO execution indication via the source SN to the source MN.

For example, the transmission indication may configure the UE to transmit the CHO execution indication via a signal radio bearer, e.g., SRB3 to the SN. In this example, the UE sends the CHO execution indication to the SN via SRB3 and SN relays this information to source MN. The MN may then initiate on-time data forwarding. In another example, the transmission indication may configure the UE to transmit the CHO execution indication via a split bearer. In this example, the UE is configured to send CHO execution condition fulfillment indication to source MN via a MN-terminated SN bearer.

The transmission indication may be transmitted as RRC message. In an embodiment, the transmission indication may be received as part of a Radio Resource Control, RRC, Reconfiguration message exchanged during establishment of the connection with the source MN. As another network implementation, an RRC message, e.g., RRC reconfiguration, triggering the herein described dual connectivity CHO can be used to configure the split SRB or SRB3 bearer to allow forwarding of CHO execution indication to the source MN. The RRC message carrying the transmission indication may in one embodiment also comprise CHO configurations of at least one target PCell of at least one target MN.

When the UE is configured by the transmission indication to transmit the CHO execution indication via the source SN to the source MN, the source MN receives the CHO execution indication from the SN. Moreover, the source MN initiates data forwarding or, generally, CHO towards a primary cell of a target MN in response to receiving the CHO execution indication from the source SN as depicted in box 602.

In an example embodiment concerning the application of the herein presented method and apparatuses for on-time data forwarding in DC-CHO, the source MN is further configured to transmit to the UE at least one CHO execution condition for CHO towards at least one target primary cell of at least one target master node. A CHO execution condition defines which conditions shall be fulfilled for performing CHO towards the target MN. If the UE receives a plurality of CHO execution conditions of a plurality of target MNs, these CHO execution conditions may be transmitted to the UE in one message, such as an RRC Reconfiguration message. Alternatively, the CHO execution conditions may be transmitted in at least two separate messages. Instead of using an RRC reconfiguration message, other messages of layer 2 or 1, such as MAC signaling or signaling the CHO execution condition via PDCCH, may be used.

In this example embodiment, the source MN may also configure the UE to perform measurements related to the received at least one CHO execution condition. For example, the UE may be configured to measure specific connection specific values, such as the synchronized signals (SSs) and/or channel state information reference signals (CSI-RSs) from the source MN and the target MN. Based on the measurements, the UE may decide whether the CHO execution condition of the target MN is fulfilled. If so, the source MN may receive a CHO execution condition fulfillment indication via the SN. In one example, the UE may maintain the connection towards the source MN, i.e., the UE may not stop communication with source MN when it determines that the CHO execution condition is fulfilled but only stops communication after sending the CHO execution condition.

Moreover, the source MN may be configured to receive the CHO execution indication via the source SN to the source MN, wherein the CHO execution indication comprises a CHO execution condition fulfillment indication. The CHO execution condition fulfillment indication comprises indication(s) about fulfillment of the CHO execution condition(s).

In one embodiment, the CHO execution condition fulfillment indication includes measurements related to a PCell of the source MN and/or a PCell of the target MN fulfilling the CHO execution condition. For example, the CHO execution condition fulfillment indication includes UE measurements related to the source PCell and/or target PCell that satisfy the CHO execution condition. In another embodiment, the CHO execution condition fulfillment indication further or alternatively includes measurements related to a plurality of cells being measured and available at the user equipment when the CHO execution condition is fulfilled. In this example, measurements for PSCells may also be included.

The CHO execution condition may be included in an RRC message. In one embodiment, this RRC message may be the same RRC message that carries the transmission indication and/or the CHO conditions of the at least one target MN. Additionally or alternatively, the CHO execution condition fulfillment indication may comprise an identification of the source MN, e.g., to enable forwarding of the message to the source MN.

Additionally or alternatively, the UE may be configured by the RRC message to report measurements related to a plurality of cells being measured and available at the user equipment when the CHO execution condition is fulfilled as described above. Additionally or alternatively, the measurement configuration configures the UE to report measurements related to a primary cell of the source SN and/or a primary cell of the target SN fulfilling the CHO execution condition as described above.

In another example embodiment concerning the application of the herein presented method and apparatuses for on-time data forwarding in DC-CHO, the source MN may be configured to receive the CHO execution indication via the source secondary node towards the source master node, in response to a determination of a radio link failure related to the connection towards the primary cell of the source master node at the UE side. In this example, the CHO execution indication comprises a CHO recovery execution indication. As the skilled person will understand, the general process of transmitting a message via the source SN to the source MN in order to ensure an on-time data forwarding in this example is mainly the same as in the other example, wherein the CHO execution indication comprises a CHO execution condition fulfillment indication. Both embodiments may be implemented together in a UE or separately.

In one example of the CHO recovery embodiment, the source MN may be configured to receive measurements related to at least one potential target primary cell of at least one potential target master node via the source secondary node towards the source master node, in response to a determination made by the UE that a radio link quality related to the connection towards the primary cell of the source master node starts to degrade according to at least one criterion. The criterion may comprise relate to a running timer for radio link failure detection, e.g., the timer being below a threshold, or receiving out-of-synch indications from lower layers.

The source MN may also be configured to receive the measurements in an RRC message, e.g., the RRC message that is used to configure the UE for CHO, in particular, for CHO recovery. For example, the RRC message, e.g., RRC reconfiguration message, may comprise measurement configuration that configures the UE to report, e.g., along with the CHO execution condition fulfillment indication or in another message, measurements related to at least one potential primary cell of the target base station and/or of at least one potential primary secondary cell of the secondary base station when a radio link quality related to the connection towards the primary cell of the source base station starts to degrade. These measurements enable on-time data forwarding for CHO recovery.

For example, before detecting radio link failure on source MN (e.g., while a timer, such as timer T310, for radio link failure detection is running or out-of-sync indications are received from lower layers), the source MN may be configured to receive, e.g., with the CHO execution condition fulfillment indication the best target PCells (with highest measurements) to source SN which in turn relays this information to source MN. Using this information, the source MN and source SN can start data forwarding to potential target cells among which the UE might select one cell for CHO recovery (which is triggered after failure detection).

After receiving the CHO execution indication via the SN, the source MN may terminate communication with the UE and start data forwarding to at least target MN. This enables data transmissions to be finished before the UE stops communication with source MN and starts random access with target MN. Moreover, this enables the source MN to know when and to which target MN the data forwarding during handover shall take place. Moreover, since the CHO execution indication is transmitted via the SN, the source MN will-even if the connection quality to the source MN is not sufficient for direct transmission-receive the information about CHO execution indication.

The source MN may also comprise means for performing the processes described herein. For example, the master MN may comprise means for transmitting a transmission indication to the user equipment, wherein the transmission indication enables the user equipment to send a CHO execution indication via the source secondary node towards the source master node and means for, in response to receiving the CHO execution indication from the secondary node, initiating data forwarding towards a primary cell of a target master node. Means for the other herein described processes may be provided as well.

A flow chart for dual connectivity conditional handover with on-time data forwarding performed by a network node supporting a gNB-CU-CP functionality is presented in FIG. 7.

The network node supports at least one of central unit control plane (gNB-CU-CP) functionality or a layer 3 protocol of a radio access network, and is configured to support connection with a user equipment operating in dual connectivity with a primary cell of the network node and with a primary secondary cell of a source secondary node.

Starting with box 701, the network node, in particular, the gNB-CU-CP of the network node, generates a Radio Resource Control (RRC) message including a transmission indication, wherein the transmission indication enables the user equipment to send a CHO execution indication via the source secondary node to the network node. Moreover, this message including the transmission indication is transmitted via a gNB-DU to the user equipment in box 702. Finally, in response to receiving the CHO execution indication in an RRC message from the source secondary node, the network node is configured to initiate data forwarding towards a primary cell of a target master node as shown in box 703. Embodiments described with respect to the source MN may also apply to the network node of FIG. 7 as will be understood by the skilled person.

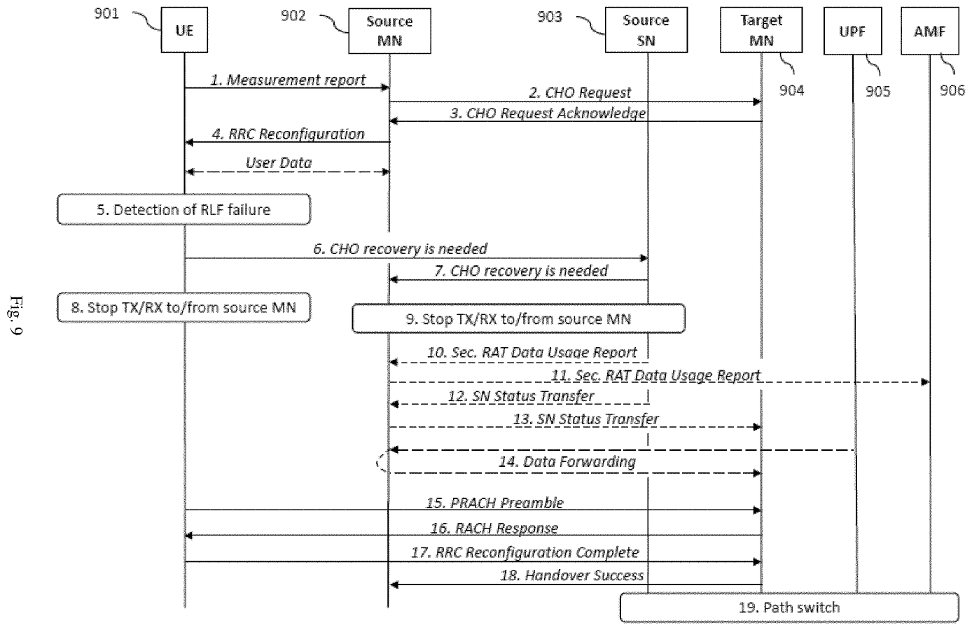

An overall message flow diagram of an embodiment of dual connectivity conditional handover with on-time data forwarding is presented in FIG. 8, wherein the CHO execution indication comprises a CHO execution condition fulfillment indication. The message flow diagram depicts a UE 801, a source MN 802, a source SN 803, a target MN 804, an UPF 805 and an AMF 806 acting during CHO according to the disclosure.

At number 1, the UE 801 sends the measurement report to source PCell of source MN 802 when the CHO preparation condition of target PCell is met. At number 2, the source PCell of source MN 802 sends CHO request to target PCell of target MN 804. At number 3, the target PCell accepts the CHO preparation request and replies with CHO request acknowledge message to source PCell. As will be understood by the skilled person, the processes of numbers 1 to 3 may also be different and do not change the general concept of the following processes.

At number 4, the source Pcell configures the UE 801 with CHO preparation configuration of target PCell along with the CHO execution condition of target PCell. In some embodiments, the UE i801 s thereby further configured to report the CHO execution condition fulfillment indication to the source MN 802 via source SN 803. Additionally or alternatively, the UE 801 might be configured to report measurements for the strongest target PCells and PSCells to source SN 803 when the radio link quality related to the connection towards the PCell of the source MN 802 starts to degrades, e.g., out-of-sync indications are received from lower layers or timer T310 has started or exceeds a certain threshold. The source SN 803 will forward the measurement report received from the UE 801 back to source MN 802.

At number 5, the UE 801 starts monitoring the CHO execution condition towards target PCell. Once the CHO execution condition is met, UE 801 continues TX/RX to/from source PCell. At number 6, the UE 801 sends the CHO execution condition fulfillment indication via the link between UE 801 and the source SN 803. In some embodiments, the CHO execution condition fulfillment indication includes the source and target PCells that meet the CHO execution condition. In another embodiments, the CHO execution condition fulfillment indication includes the measurements related to the cells that are configured by the source PCell, e.g., at number 4 to be reported. In some embodiment, the CHO execution condition fulfillment indication includes the UE measurements related to all cells that are measured and available at the UE 801 when the CHO execution condition was met.

At number 7, the source SN 803 relays the CHO execution condition fulfillment indication to source MN 802. In one embodiment, the UE send the CHO execution condition fulfillment indication to the source SN 803 via SRB3. In that case, the source SN 803 forwards this message to source MN 802 via an explicit message. In another alternative, the UE sends the CHO execution condition fulfillment indication to source MN 802 via split bearers. In that case, source SN 803 does not have to send an explicit message to source MN 802 as the message will be carried out via the split SRB between source MN 802 and source SN 803.

The way that UE 801 should convey the CHO execution condition fulfillment indication can be specified by source MN 802 in the RRC Reconfiguration message (at number 4). In case the measurements related to the cells that are configured by the source PCell are provided to the SN, these are forwarded to the source MN 802 as well. UE 801 stops the TX/RX to from source node as soon as the CHO execution condition fulfillment indication is sent to the network in number 6. At number 9, the source PCell and source PSCell initiate the data forwarding towards target PCell as soon as it receives the CHO execution condition fulfillment indication from UE 801 via source SN 803. The source PCell/PSCell may decide to start data forwarding to more than one nodes, based on the measurements related to the cells that are provided by the UE 801 in step 6 and relayed to MN in number 7.

Numbers 10 to 14 relate to data forwarding between source PCell/source PSCell and target PCell as known, e.g., from the NR 3GPP standards, Release 17. Numbers 15 to 19 relate to the random access procedure as known, e.g., from the NR 3GPP standards, Release 16. Handover success and path switch function in numbers 18 and 19 are executed in parallel to the on-time data forwarding (numbers 9 to 14) as those are independent processes. As will be understood by the skilled person, the processes of numbers 10 to 14 may also be different and do not change the general concept of the previous processed described with respect to number 4 to 9.

Once the CHO execution is completed successfully, i.e., HO success message is sent from target PCell to source PCell, the target PCell can initiate the data session between UE 801 and the target PCell as the data forwarding has been performed on time.

An overall message flow diagram of an embodiment of dual connectivity conditional handover with on-time data forwarding is presented in FIG. 9, wherein the CHO execution indication comprises a CHO recovery indication. The message flow diagram depicts a UE 901, a source MN 902, a source SN 903, a target MN 904, an UPF 905 and an AMF 906 acting during CHO according to the disclosure.

Numbers 1 to 4 correspond to that of FIG. 8. In number 5, the UE 901 does not detect that a CHO condition is met but recognizes a radio link failure related to the connection towards the primary cell of the source MN 904. In this example, the UE 901 selects a suitable CHO configuration of the target MN 904 and informs the source MN 902 via the source SN 903 about this decision in numbers 6 and 7. Numbers 8 to 19 again correspond to that of FIG. 8.

The proposed solution prevents the interruption time that UE experiences due to late data forwarding where the source MN or SN forwards the user plane packets with the target MN/SN as soon as the CHO execution condition is met or a decision on CHO recovery has been made. Besides, the solution does not introduce any overhead that is caused by early data forwarding as the source MN/SN knows when the data forwarding is needed, e.g., on-time.

It should be understood that the apparatuses described herein may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

1-78. (canceled)

79. A user equipment configured to support operating in dual connectivity within at least one radio access network, RAN, and configured to support conditional handover, CHO, the user equipment comprising:
at least one processor, and
at least one memory including computer program code causing the user equipment, when executed with the at least one processor, to:
establish a connection towards a primary cell of a source master node;
establish a connection towards a primary secondary cell of a source secondary node;
receive a transmission indication from the source master node, wherein the transmission indication enables the user equipment to send a CHO execution indication via the source secondary node towards the source master node;
transmit the CHO execution indication via the source secondary node towards the source master node; and
process CHO towards a primary cell of a target master node.

80. The user equipment of claim 79, wherein the transmission indication further configures the user equipment how to transmit the CHO execution indication via the source secondary node towards the source master node.

81. The user equipment of claim 80, wherein the user equipment is configured to transmit the CHO execution indication via at least one of a signal radio bearer or a split bearer terminated at the source master node towards the source secondary node.

82. The user equipment of claim 79, wherein the transmission indication is received as part of a Radio Resource Control, RRC, Reconfiguration message.

83. The user equipment of claim 79, wherein the transmission indication is received as part of a Radio Resource Control, RRC, Reconfiguration message which further comprises CHO configurations of at least one target primary cell of at least one target master node.

84. The user equipment of claim 79, wherein the transmission indication is received as part of a Radio Resource Control, RRC, Reconfiguration message exchanged during establishment of the connection with the source master node.

85. The user equipment of claim 79 being further caused to:
receive, from the source master node, at least one CHO execution condition for CHO towards at least one target primary cell of at least one target master node;
perform measurements related to the received at least one CHO execution condition; and
in response to at least one of the at least one CHO execution condition being fulfilled for the target master node based on the measurements, transmit the CHO execution indication via the source secondary node towards the source master node, wherein the CHO execution indication comprises a CHO execution condition fulfillment indication.

86. The user equipment of claim 85 being further caused to:
when transmitting the CHO execution condition fulfillment indication, maintain the connection towards at least the primary secondary cell of the source secondary node for continued data transmission and receipt; and
after transmitting the CHO execution condition fulfillment indication, terminate the connection towards the primary cell of the source master node for stopping data transmission and receipt.

87. The user equipment of claim 85, wherein the CHO execution condition fulfillment indication includes measurements related to the primary cell of the source master node and to a primary cell of the target master node fulfilling the CHO execution condition.

88. The user equipment of claim 85, wherein the CHO execution condition fulfillment indication further includes measurements related to a plurality of cells being measured at the user equipment and available when the CHO execution condition is fulfilled.

89. The user equipment of claim 85, wherein the CHO execution condition is received as part of a Radio Resource Control, RRC, Reconfiguration message.

90. The user equipment of claim 85, wherein the CHO execution condition is included in the same message as at least one of the CHO transmission indication or CHO configurations of the at least one target primary cell of the at least one target master node.

91. The user equipment of claim 85, wherein the message used to transmit the CHO execution condition fulfillment indication further comprises an identification of the source master node.

92. The user equipment of claim 79 being further caused to:
in response to a determination of a radio link failure related to the connection towards the primary cell of the source master node, transmit the CHO execution indication via the source secondary node towards the source master node, wherein the CHO execution indication comprises a CHO recovery execution indication.

93. The user equipment of claim 79 being further caused to:
in response to a determination that a radio link quality related to the connection towards the primary cell of the source master node starts to degrade according to at least one criterion, transmit the CHO execution indication via the source secondary node towards the source master node, wherein the CHO execution indication comprises measurements related to at least one potential target primary cell of at least one potential target master node via the source secondary node towards the source master node.

94. The user equipment of claim 93, wherein the at least one criterion comprises at least one threshold, and radio link quality degradation below threshold is determined while a timer for radio link failure detection is running or after receiving out-of-synch indications from lower layers.

95. A source master node configured to support establishing connection towards a user equipment configured to support operating in dual connectivity with a primary cell of the source master node and with a primary secondary cell of a source secondary node and supporting for conditional handover, CHO, the source master node comprising:
at least one processor, and
at least one memory including computer program code causing the source master node, when executed with the at least one processor, to:
transmit a transmission indication to the user equipment, wherein the transmission indication enables the user equipment to send a CHO execution indication via the source secondary node towards the source master node; and
in response to receiving the CHO execution indication from the source secondary node, initiate data forwarding towards a primary cell of a target master node.

96. The source master node of claim 95, wherein the transmission indication further configures the user equipment how to transmit the CHO execution indication via the source secondary node towards the source master node.

97. The source master node of claim 96, wherein the transmission indication configures the user equipment to transmit the CHO execution indication via at least one of a signal radio bearer or a split bearer terminated at the source master node towards the source secondary node.

98. The source master node of claim 95, wherein the transmission indication is received as part of a Radio Resource Control, RRC, Reconfiguration message.

99. The source master node of claim 95, wherein the transmission indication is received as part of a Radio Resource Control, RRC, Reconfiguration message which further comprises CHO configurations of at least one target primary cell of at least one target master node.

100. The source master node of claim 95, wherein the transmission indication is received as part of a Radio Resource Control, RRC, Reconfiguration message exchanged during establishment of the connection with the source master node.

101. The source master node of claim 95, being further caused to:
transmit at least one CHO execution condition for a conditional handover towards at least one target primary cell of at least one target master node; and
receive the CHO execution indication from the source secondary node, wherein the CHO execution indication comprises a CHO execution condition fulfillment indication.

102. The source master node of claim 101 being further caused to:
in response to receiving the CHO execution condition fulfillment indication, terminate the connection towards the user equipment for stopping data transmission and receipt.

103. The source master node of claim 101, wherein the CHO execution condition fulfillment indication includes measurements related to the primary cell of the source master node and to a primary cell of the target master node fulfilling the CHO execution condition.

104. The source master node of claim 101, wherein the CHO execution condition fulfillment indication further includes measurements related to a plurality of cells being measured at the user equipment and available when the CHO execution condition is fulfilled.

105. The source master node of claim 101, wherein the CHO execution condition is transmitted as part of a Radio Resource Control, RRC, message.

106. The source master node of claim 101, wherein the CHO execution condition is included in the same message as at least one of the CHO transmission indication or CHO configurations of the at least one target primary cell of the at least one target master node.

107. The source master node of any one of claims 101 wherein the message used to transmit the CHO execution condition fulfillment indication further comprises an identification of the source master node.

108. The source master node of claim 101 being further caused to:
receive the CHO execution indication from the source secondary node, wherein the CHO execution indication comprises a CHO recovery execution indication, wherein the CHO recovery execution indication is transmitted in response to a determination of a radio link failure related to the connection towards the primary cell of the source master node by the user equipment.

109. The source master node of claim 95 being further caused to:
receive the CHO execution indication via the source secondary node, wherein the CHO execution indication comprises measurements related to at least one potential target primary cell of at least one potential target master node from the source secondary node, wherein the measurements are transmitted in response to a determination by the user equipment that a radio link quality related to the connection towards the primary cell of the source master node starts to degrade according to at least one criterion.

110. The source master node of claim 109, wherein the at least one criterion comprises at least one threshold, and radio link quality degradation below threshold is determined while a timer for radio link failure detection is running or after receiving out-of-synch indications from lower layers.

111. A network node that supports at least one of central unit control plane functionality or a layer 3 protocol of a radio access network, configured to support connection with a user equipment operating in dual connectivity with a primary cell of the network node and with a primary secondary cell of a source secondary node, and configured for conditional handover, CHO, the network node comprising:
at least one processor, and
at least one memory including computer program code causing the network node,
when executed with the at least one processor, to:
generate a Radio Resource Control, RRC, message including a transmission indication, wherein the transmission indication enables the user equipment to send a CHO execution indication via the source secondary node towards the network node;
transmit the Radio Resource Control, RRC, message including the transmission indication to the user equipment; and
in response to receiving the CHO execution indication in a Radio Resource Control, RRC, message from the source secondary node, initiate data forwarding towards a primary cell of a target master node.
